(19) United States
(12) Patent Application Publication
(10) Pub. No.: US 2010/0063856 A1
(43) Pub. Date: Mar. 11, 2010

(54) APPARATUS AND METHODS FOR PROVIDING BUSINESS ACTIVITY MONITORING

(75) Inventors: Geoffrey R. Williams, Midlothian, TX (US); Timothy J. Mark, San Francisco, CA (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/208,506

(22) Filed: Sep. 11, 2008

(51) Int. Cl. G06Q 10/00

(52) U.S. Cl. 705/7

(57) ABSTRACT

Apparatus and methods for providing a business activity monitoring system. The apparatus and methods may involve monitoring a plurality of business activities that take place within a business communication network; formulating a monitoring program for activities that extend from inside the network to a platform outside the network; and, providing a business activity monitoring system that is configured to monitor activities on the business platform that is outside the network.

### FIELD OF TECHNOLOGY

Aspects of the disclosure relate to providing business activity monitoring. In particular, the disclosure relates to providing business activity monitoring for a system that interacts with a monitored network.

### BACKGROUND

A business may use a business activity monitoring system to monitor performance of its business processes. Performance may be quantified in terms of efficiency, accuracy and other performance metrics. The business activity monitoring system may incorporate data feeds from selected elements of the business processes. The feeds may include specially structured data objects that can be used to track the progress and status of processes.

The business may desire “end-to-end” business activity monitoring. End-to-end business activity monitoring ideally monitors one or more designated processes in the business communication network from the time the process is initiated until the time at which the process is terminated. The process may be initiated by an input to the business communication network. The process may be terminated when the business communication system generates an output corresponding to the input.

The business communication network may exchange information, services and products with a value added network that supports or otherwise relates to processes of the business communication network. The value added network may be “external” to the business communication network. Typically, value added networks are not supported by business activity monitoring.

It may be difficult and expensive to provide a business activity monitoring system for a business communication network. The difficulty and expense may depend in part on requirements for monitoring activities that bridge across different networks. Bridges across networks require obtaining access to data from one network to another. The difficulty and expense may depend also on integration of different data object formats from the different networks. Because value added networks are often small and by nature interact with many other networks, it is typically not cost-efficient to provide a business activity monitoring system to a value added network. Nevertheless, there is a demand for the services of value added networks and there is a commercial need for the value added networks to provide the services in a monitored manner.

It would be desirable, therefore, to provide apparatus and methods for providing a business activity monitoring system.

### SUMMARY OF THE INVENTION

It is an object of the invention to provide apparatus and methods for to provide apparatus and methods for providing a business activity monitoring system. Apparatus and methods for providing a business activity monitoring system are therefore provided.

The apparatus and methods may involve monitoring a plurality of business activities that take place within a business communication network; formulating a monitoring program for activities that extend from inside the network to a platform outside the network; and, providing a business activity monitoring system that is configured to monitor activities on the business platform that is outside the network.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of apparatus that may be used in accordance with the principles of the invention;

FIG. 2 shows an illustrative system that may be used in accordance with the principles of the invention;

FIG. 3 shows a flow chart of an illustrative method in accordance with the principles of the invention;

FIG. 4 shows an illustrative feature of a method such as that shown in FIG. 3;

FIG. 5 shows another illustrative feature of a method such as that shown in FIG. 3;

FIG. 6 shows yet another illustrative feature of a method such as that shown in FIG. 3; and

FIG. 7 shows still another illustrative feature of a method such as that shown in FIG. 3.

### DETAILED DESCRIPTION OF THE INVENTION

An entity may use a business communication network to conduct business. Business communication network may support the plurality of business activities. The activities may be monitored to improve or maintain performance of the business communication network. A value added network may provide a service or a product to the entity. When the entity provides a service to the entity's customers, the value added network may be viewed as being provided by a “third party.”

When the value added network provides such a service, business activities may take place that involve processes within the business communication network and processes that take place within the value added network. The processes that take place within the value added network may take place on a platform that is outside the business communication network.

For example, the value added network platform may process data or images provided by the entity. The value added network platform may provide to the entity information products based on the data or images. The information products may be generated within the value added network. The information products may be generated in part or whole by a party that is outside both the business communication network and the value added network.

The monitoring of activities that involve a process in the business communication network and a process on the value added network platform may involve the use of a framework for implementing a business activity monitoring system. The framework may involve the formulation of protocols and data structures that are compatible with both the business communication network and the value added network platform. For example, the framework may include protocols and data structures for monitoring send and receive processes. The send and receive processes may involve the business communication network and a financial services industry value added network such as an image exchange network. Once the protocols and data structures are formulated, the protocols and data structures may be used, along with other protocols and data structures, as appropriate, to monitor business activities between two processes that are both within the value added network.

The framework may then be used, in whole or in part, to monitor business activities that involve a process in the value added network and a process owned or controlled by a “fourth party.” The fourth party may be any suitable party, such as any retail or corporate party that engages the services of the value added network. The fourth party may be external to the entity and/or its business communication network. The fourth party may be internal to the entity.

Apparatus and methods in accordance with the principles of the invention may involve: monitoring a plurality of business activities that take place within a business communication network; formulating a monitoring program for at least one activity that involves a first process inside the business communication network and a second process that is executed on a business platform that is outside the business communication network; and providing a business activity monitoring system that is configured to monitor activities on the business platform that is outside the network.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

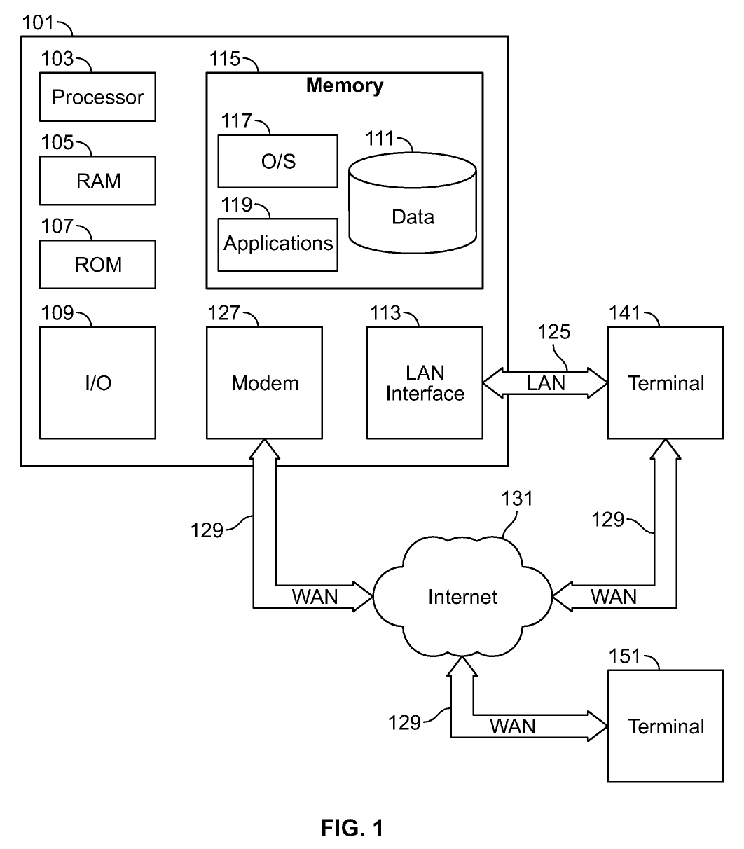

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown). As described in detail below, database 111 may provide storage for business activity monitoring data, business activity monitoring protocols, network communication parameters and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

One or more of applications 119 may include one or more algorithms that may be used to monitor business activities and perform any other suitable tasks related to monitoring business activities.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

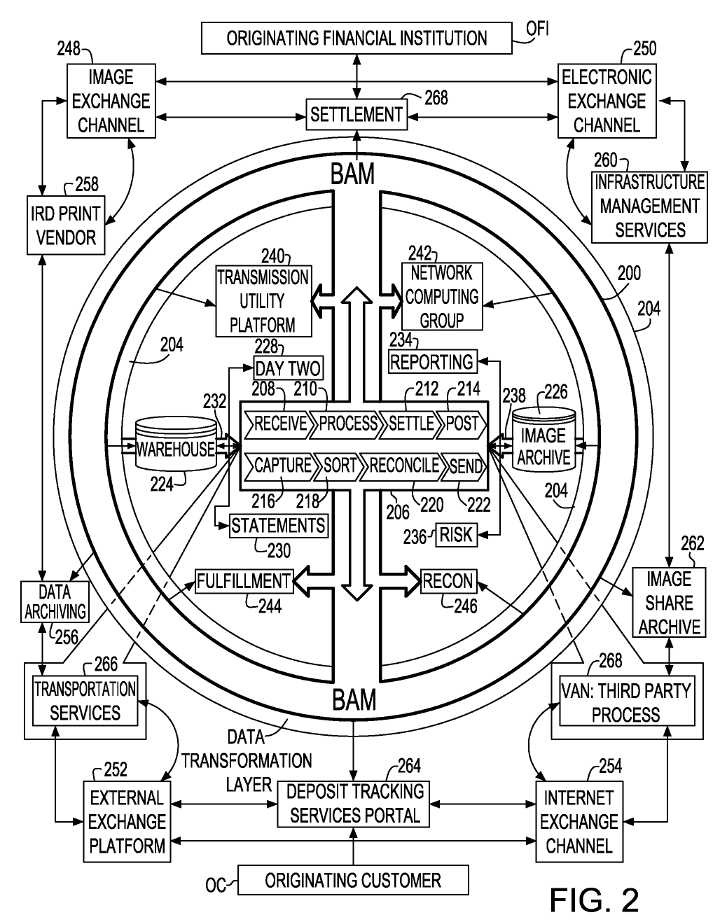

FIG. 2 schematically shows illustrative business activities monitoring (“BAM”) system 200. Business activities monitoring system 200 may be an end-to-end business activities monitoring system. Business activities monitoring system 200 may monitor business activities in business communication network 202. Business communication network 202 may support the execution of a business transaction, such as the presentment of a check by originating customer OC to originating financial institution OFI for deposit.

Business activities monitoring system 200 is shown as circumscribing business communication network 202 with a “BAM Ring.” A process that is executed within the BAM ring may be referred to as an “internal” process. A process that is executed outside of the BMA Ring may be referred to as an “external” process.

The BAM Ring may be operationally coextensive with data transformation layer 204. Data transformation layer 204 is a centralized logic layer that may be used to standardize the data used or generated within the BAM Ring and map business-critical data elements to a standard data format. Process outputs that conform to the requirements of data transformation layer 204 may be fed to business activities monitoring system 200.

A firewall (not shown) may be operationally coextensive with the BAM Ring.

Hub 206 may be operational within the BAM Ring. Hub 206 may include processes that capture and process paper and image items. The processes in hub 206 may include, for example, processes that are employed by financial services institutions in connection with execution of monetary transactions. The transactions may be paper-based, image-based and/or electronic transactions. In the example shown in FIG. 2, hub 206 may include receive 208, process 210, settle 212 and post 214. Steps 208, 210, 212 and 214 may be a basis for executing a paper-based transaction (e.g, the presentment of a paper check). Hub 206 may include capture 216, sort 218, reconcile 220 and send 222. Steps 216, 218, 220 and 222 may be a basis for executing an image-based transaction.

Paper and image items from warehouse 224 may be provided to the processes of hub 206. Images produced by hub 206 may be stored in image archive 226. Analytical and reporting engines such as “Day Two” 228 and “statements” 230 may be fed by data feeds that stem from input 232 of hub 206. Day Two 228 may handle returned exceptional items. Statements 230 may generate customer statements. Information products “reporting” 234 and “risk” 236 may be fed by data feeds that stem from output 238 of hub 206. Reporting 234 may handle Information Delivery and reporting interfaces, such as a customer reporting interface. Risk 236 may handle liability and risk management in connection with transactions such as those handled by business communication network 202.

Other illustrative processes that may be present in business communication network 202 include transmission utility platform 240, network computing group 242, fulfillment engine 244 and reconciliation (“Recon”) engine 246. Transmission utility platform 240 may be an image exchange channel that is internal to business communication network 202. Network computing group 242 may include network infrastructure and application management. Fulfillment engine 242 may include tools and individuals for research and adjustment of transaction data and instruments. Recon engine 246 may handle general ledger reconciliation for originating financial institution OFI.

The aforementioned components of business communications network 202 communicate with each other, at least in part, by exchanging data objects that conform to standards associated with, and/or defined in, data transport layer 204. Each data object may correspond to a business information unit, such as a paper or image check or an order for an electronic fund transfer or any other suitable unit of business information. Status information relating to a business information unit may be mapped into the data object so that business activity monitoring system 200 can track activity status.

For example, the status information may relate to one or more of: receipt of the business information unit by an identified processor that is monitored by business activity monitoring system 200; partial or full completion of an identified task in a process performed by an identified processor; settlement of a transaction involving the business information unit by a settlement platform; posting of a transaction involving the business information unit by a posting platform; capture of an image of the business information unit by an image capture engine; sorting of the business information unit by a sorting engine; reconciliation of a general ledger account based on processing the business information unit by a reconciliation engine; sending (or transmission) of the business information unit from, or to, a designated processor; and/or any other suitable status information. The status of the business information units may thus be tracked using business activity monitoring system 200.

The transaction between originating customer OC and originating financial institution OFI may involve numerous channels and platforms that are outside business activity monitoring system 200, data transport layer 204 and/or the aforementioned firewall (not shown).

Those channels and platforms may include image exchange channel 248, electronic exchange channel 250, external exchange platform 252 and internet exchange channel 254. Image exchange channel 248 may be a secure channel through which two financial institutions may exchange an image of a transaction instrument such as a check. One example of an image exchange channel is that sold under the trademark SVPCO by The Clearinghouse Payments Company, LLC, of New York, N.Y. Electronic exchange channel 250 may be a secure channel through which two financial institutions may exchange data that are the basis for an electronic transaction. One example of an electronic exchange channel is that made available under the trademark SWIFT by the Society for Worldwide Interbank Telecommunication, Belgium. External exchange platform 252 may be a secure channel through which two financial institutions may exchange an image based or electronic transactions. One example of an external exchange platform is the Electronic Data Transmission Utility Platform (“EDTUP”) . Internet exchange channel 254 may be an unsecure channel through which two financial institutions can exchange data related to the transaction. A remote deposit service is an example of an internet exchange channel.

The transaction between originating customer OC and originating financial institution OFI may involve numerous services that are outside business activity monitoring system 200, data transport layer 204 and/or the aforementioned firewall (not shown).

Those services may include image data archiving 256 (e.g., that sold under the trademark IRON MOUNTAIN by Iron Mountain, Incorporated of Boston, Mass.), image replacement document (“IRD”) print vending service 258 (e.g., that sold under the trademark FISERV by Fiserv, Inc., of Brookfield, Wis.), infrastructure management services 260 (e.g., electronic data services (“EDS”), help desk support and the like), image share archive 262 (e.g., that sold under the trademark VIEWPOINTE by Viewpointe Archive Services LLC of Charlotte, N.C.), deposit tracking services portal 264 (e.g., the International Financial Services Web Portal), transportation services 266 (e.g., e2e tracking of pickups and deliveries), settlement service 268 and any other suitable service.

The transaction between originating customer OC and originating financial institution OFI may involve products and services provided by a value added network that is outside business activity monitoring system 200, data transport layer 204 and/or the aforementioned firewall (not shown).

Value added network (“VAN: Third Party Process”) 268 is an example of such a value added network. VAN 268 may be a network, system or service provided by any suitable third party organization. The entity using business communication network 202 may leverage VAN 268 for outsourced, shared or owned services. The services may include, but are not limited to, automated clearinghouse (“ACH”) processing and any other suitable services.

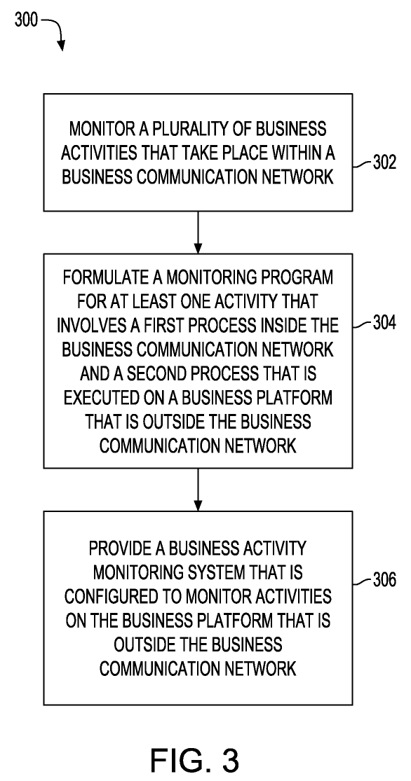

Processes in accordance with the principles of the invention may include one or more features of the illustrative processes illustrated in FIGS. 3-7. The processes illustrated in FIGS. 3-7 are processes that may be used to provide a business activity monitoring system for a value added network such as VAN 268 (shown in FIG. 2).

For the sake of illustration, the processes illustrated in FIGS. 3-7 will be described as being performed by a “system”. The “system” may involve one or more of the devices shown in FIG. 1, one or more of the features shown in FIG. 2, one or more individuals and/or any other suitable device or approach. The “system” may be provided by an entity. The entity may be an individual, an organization or any other suitable entity.

FIG. 3 shows illustrative process 300 for providing a business activity monitoring system to monitor activities on a business platform outside a business communication network. Process 300 may begin at step 302. At step 302, the system may monitor a plurality of business activities that take place within the business communication network. At step 304, the system may formulate a monitoring program for at least one activity that involves a first process inside the business communication network and a second process that is executed on a business platform that is outside the business communication network. At step 306, the system may provide a business activity monitoring system that is configured to monitor activities on the business platform that is outside the business communication network.

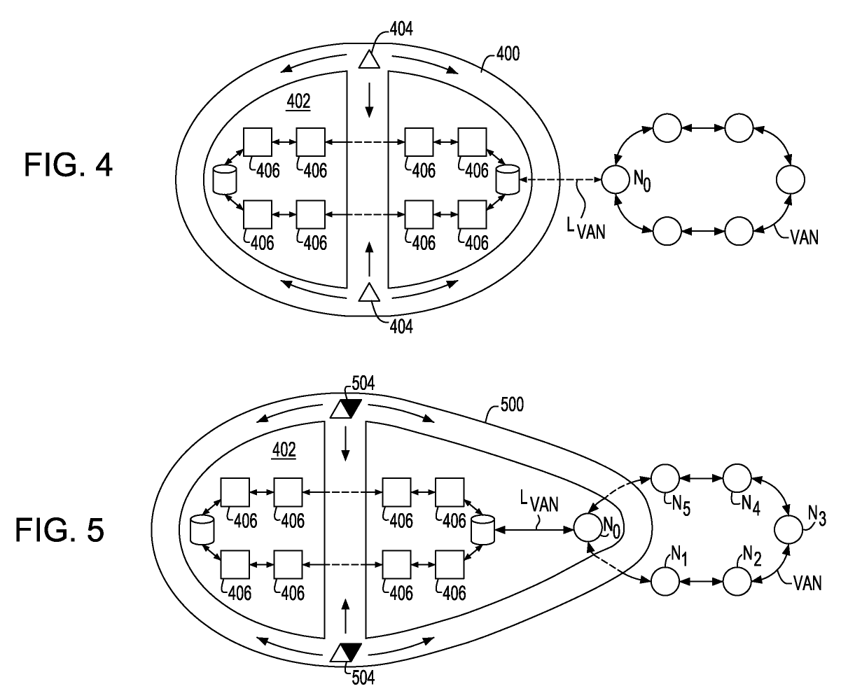

FIGS. 4-7 illustrate steps that may be taken in connection with a process such as 300 (shown in FIG. 3).

FIG. 4 shows illustrative BAM Ring 400 operating with respect to business communication network 402. BAM Ring 400 may be controlled by the system that performs the steps of process 300 (shown in FIG. 3) or any other suitable system. A data transport layer corresponding to BAM Ring 400 is represented by data objects 404. Data objects 404 conform to protocols and data structures that are used to track processes performed by modules 406 of business communication network 402.

Value added network VAN is external to business communication network 402. Node N₀ of value added network VAN may provide a service via external link L_{VAN} to an entity that uses business communication network 402. Link L_{VAN} is not encompassed by BAM Ring 400.

FIG. 5 shows that BAM Ring 400 may be replaced by, or further developed into, illustrative BAM Ring 500. BAM Ring 500 may be controlled by the system that performs the steps of process 300 (shown in FIG. 3) or any other suitable system. A data transport layer corresponding to BAM Ring 500 is represented by data objects 504. Like data objects 404, data objects 504 conform to protocols and data structures that are used to track processes performed by modules 406 of business communication network 402. Data objects 504 also conform to protocols and data structures that are used to track processes performed by modules Nᵢ (i=0, 1, 2, . . . ) of value added network VAN. Because data objects 504 conform to the requirements of both business communication network 402 and value added network VAN, BAM Ring 500 can encompass VAN link L_{VAN}. Processes that are performed by node No in value added network VAN are now monitored by BAM Ring 500.

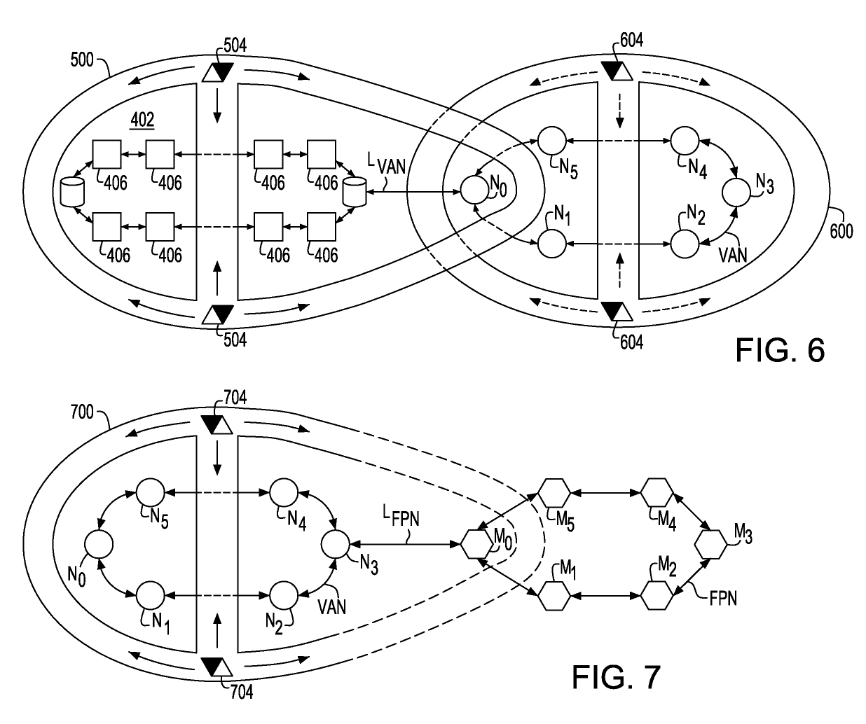

FIG. 6 shows illustrative BAM Ring 600. BAM Ring 600 may encompass value added network VAN. A data transport layer corresponding to BAM Ring 600 is represented by data objects 604. Like data objects 504, data objects 604 conform to protocols and data structures that are used to track processes performed by modules Nᵢ (i=0, 1, 2, . . . ) of value added network VAN. In some embodiments of the invention, BAM Ring 600 may include an interface with BAM Ring 500. In some embodiments of the invention, BAM Ring 600 may be operationally independent from BAM Ring 500.

In embodiments in which BAM Ring 600 is operationally independent from BAM Ring 500, BAM Ring 600 may be controlled by a system that is independent from the system that controls BAM Ring 500. The independent system may have some or all of the features that may be present in the system that controls process 300 (shown in FIG. 3) or any other suitable features.

FIG. 7 shows that BAM Ring 600 may be replaced by, or further developed into, illustrative BAM Ring 700. BAM Ring 700 may be controlled by the system that controls BAM Ring 600 or by an independent system. A data transport layer corresponding to BAM Ring 700 is represented by data objects 704. Like data objects 604, data objects 704 conform to protocols and data structures that are used to track processes performed by modules Nᵢ of value added network VAN (shown in FIG. 6). Data objects 704 also conform to protocols and data structures that are used to track processes performed by modules Mᵢ (i=0, 1, 2, . . . ) of fourth party network FPN. Because data objects 704 conform to the requirements of both value added network VAN and fourth party network FPN, BAM Ring 700 can encompass fourth party network link L_{FPN} between node M₀ and value added network VAN. Processes that are performed by node M₀ in fourth party network FPN are now monitored by BAM Ring 700.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for providing a business activity monitoring system have been provided. Persons skilled in the art will appreciate that the present invention can be practiced by other than the described embodiments, which are presented for purposes of illustration rather than of limitation. The present invention is limited only by the claims that follow.

What is claimed is:

1. A method for providing a business activity monitoring system, the method comprising:
monitoring a plurality of business activities that take place within a business communication network;
formulating a monitoring program for at least one activity that involves a first process inside the network and a second process that is executed on a business platform that is outside the network; and,
based on the formulating, providing a business activity monitoring system that is configured to monitor activities on the business platform that is outside the network.

2. The method of claim 1 wherein providing the business activity monitoring system comprises providing a business activity monitoring system that is configured to monitor an activity that originates on the business platform.

3. The method of claim 1 wherein providing the business activity monitoring system comprises providing a business activity monitoring system that is configured to monitor an activity that terminates on the business platform.

4. The method of claim 1 wherein providing the business activity monitoring system comprises providing a business activity monitoring system that is configured to monitor an activity that takes place exclusively on the business platform.

5. The method of claim 1 wherein, when the business communication network is a first business communication network and the business platform is part of a second business communication network, providing the business activity monitoring system comprises providing a system that is configured to monitor an activity that takes place between a processor on the business platform and a processor that is (a) within the second business communication network and (b) off the business platform.

6. The method of claim 5 wherein providing the business activity monitoring system comprises providing a business activity monitoring system that is configured to monitor an activity that originates at the processor on the business platform.

7. The method of claim 6 wherein providing the business activity monitoring system comprises providing a business activity monitoring system that is configured to monitor an activity that originates at the processor on the business platform and terminates at the processor that is within the second business communication network and is off the business platform.

8. The method of claim 5 wherein providing the business activity monitoring system comprises providing a business activity monitoring system that is configured to monitor an activity that originates at the processor that is within the second business communication network and is off the business platform.

9. The method of claim 8 wherein providing the business activity monitoring system comprises providing a business activity monitoring system that is configured to monitor an activity that originates at the processor that is within the second business communication network and is off the business platform and terminates at the processor on the business platform.

10. The method of claim 5 wherein the providing the business activity monitoring system further comprises selecting a format for a data object that is processed as part of the activity that takes place between the processor on the business platform and the processor that is (a) within the second business communication network and (b) off the business platform;
wherein the data object corresponds to a business information unit that is a subject of the activity.

11. The method of claim 10 wherein the selecting a format comprises assigning to the data object a parameter that corresponds to a state of the unit of business information.

12. The method of claim 11 wherein the assigning comprises assigning a parameter that corresponds to a receipt state.

13. The method of claim 11 wherein the assigning comprises assigning a parameter that corresponds to a process state.

14. The method of claim 11 wherein the assigning comprises assigning a parameter that corresponds to a settlement state.

15. The method of claim 11 wherein the assigning comprises assigning a parameter that corresponds to a post state.

16. The method of claim 11 wherein the assigning comprises assigning a parameter that corresponds to a capture state.

17. The method of claim 11 wherein the assigning comprises assigning a parameter that corresponds to a sort state.

18. The method of claim 11 wherein the assigning comprises assigning a parameter that corresponds to a reconcile state.

19. The method of claim 11 wherein the assigning comprises assigning a parameter that corresponds to a send state.

20. A system for monitoring a business activity initiated in a first business communication network and completed in a second business communication network, the system comprising:
a receiver configured to be linked to the first business communication network and the second business communication network;
a processor in communication with the receiver, the processor being configured to receive via the receiver a first data object from a node in the first business communication network and a second data object from a node in the second business communication network;
wherein:
the first data object and the second data object have the same data format; and
the processor is further configured to compare the first data object to the second data object to determine a status of the business activity.

21. The system of claim 20 wherein the receiver is configured to receive a first data feed from the first business communication network and a second data feed from the second business network;
wherein:
the first data object is delivered by the first data feed; and
the second data object is delivered by the second data feed.

22. The system of claim 20 further comprising a reporting module configured to output the status to a system user.

23. The system of claim 20 wherein, when the business activity is a first business activity:
the processor is configured to receive via the receiver a third data object from the node in the second business communication network and a fourth data object from another node in the second business communication network;
wherein:
the third data object and the fourth data object have the same data format; and
the processor is further configured to compare the third data object to the fourth data object to determine a status of a second business activity that originates and terminates in the second business communication network.
